(19) United States
(12) Patent Application Publication
(10) Pub. No.: US 2013/0021470 A1
(43) Pub. Date: Jan. 24, 2013

(54) METHOD AND APPARATUS FOR COLLECTION OF DATA USEFUL FOR GEOMETRIC MODELING

(71) Applicant: DAVID HOLMES, Quaker Hill, CT (US)

(72) Inventor: DAVID HOLMES, Quaker Hill, CT (US)

(21) Appl. No.: 13/189,521

(22) Filed: Jul. 24, 2011

(51) Int. Cl. H04N 7/18; H04N 5/225; G06K 9/36

(52) U.S. Cl. 348/135; 382/286; 348/373; 348/E07.085

(57) ABSTRACT

A method for collecting data for geometric modeling of a physical object which includes: providing a first housing; providing an aperture in the first housing; providing a source of light within the housing that is strong enough to be perceptible in the ambient conditions at the aperture; providing a video recorder in a second housing; providing a rigid follower dimensioned and configured for following the surface of the physical object; rigidly fixing the rigid follower to one of the housings; and translating the follower along the surface of the physical object and simultaneously using the video recorder to video record the path of the aperture. Other embodiments of the present invention also include a method for guiding a tool. Still other embodiments of the present invention include a method for replicating a part.

### FIELD OF THE INVENTION

The present invention has particular application to methods and apparatus for collecting data for geometric modeling. Geometric modeling is a branch of applied mathematics and computational geometry that studies methods and algorithms for the mathematical description of shapes.

The shapes studied in geometric modeling are mostly two- or three-dimensional, although many of its tools and principles can be applied to sets of any finite dimension. Today most geometric modeling is done with computers and for computer-based applications. Two-dimensional models are important in computer typography and technical drawing. Three-dimensional models are central to computer-aided design and manufacturing (CAD/CAM), and widely used in many applied technical fields such as civil and mechanical engineering, architecture, geology and medical image processing.

Geometric models are usually distinguished from procedural and object-oriented models, which define the shape implicitly by an opaque algorithm that generates it's appearance. They are also contrasted with digital images and volumetric models which represent the shape as a subset of a fine regular partition of space and with fractal models that give an infinitely recursive definition of the shape. However, these distinctions are often blurred: for instance, a digital image can be interpreted as a collection of colored squares; and geometric shapes such as circles are defined by implicit mathematical equations. Also, a fractal model yields a parametric or implicit model when its recursive definition is truncated to a finite depth.

### GLOSSARY

The following definitions provide background to the description of the preferred embodiments:

Tangent space—In mathematics, the tangent space of a manifold facilitates the generalization of vectors from affine spaces to general manifolds, since in the latter case one cannot simply subtract two points to obtain a vector pointing from one to the other.

Manifold—a manifold is a topological space that on a small enough scale resembles the Euclidean space of a specific dimension.

Affine transformation—In general, an affine transformation is composed of linear transformations (rotation, scaling or shear) and a translation (or “shift”). Several linear transformations can be combined into a single one, so that the general formula given above is still applicable.

Homogeneous coordinates—A system of coordinates used in projective geometry much as Cartesian coordinates are used in Euclidean geometry.

Tangent—In geometry, the tangent line (or simply the tangent) to a curve at a given point is the straight line that “just touches” the curve at that point. As it passes through the point where the tangent line and the curve meet, or the point of tangency, the tangent line is “going in the same direction” as the curve, and in this sense, it is the best straight-line approximation of the curve at that point. The same definition applies to space curves and curves in n-dimensional Euclidean space. The tangent plane to a surface at a given point p is defined in an analogous way to the tangent line in the case of curves. It is the best approximation of the surface by a plane at p, and can be obtained as the limiting position of the planes passing through 3 distinct points on the surface close to p as these points converge to p. More generally, there is a k-dimensional tangent space at each point of a k-dimensional manifold in the n-dimensional Euclidean space.

Affine space—In mathematics, an affine space is a geometric structure that generalizes the affine properties of Euclidean space. In an affine space, one can subtract points to get vectors, or add a vector to a point to get another point, but one cannot add points. In particular, there is no distinguished point that serves as an origin.

Space curve—A curve for which X is of three dimensions, usually Euclidean space; a skew curve is a space curve which lies in no plane. These definitions also apply to algebraic curves. However, in the case of algebraic curves it is very common not to restrict the curve to having points only defined over the real numbers.

### BACKGROUND OF THE INVENTION

The prior art includes the following United States patents issued to the present inventor:

Computerized Method for Decomposing a Geometric Model of Surface or Volume into Finite Elements, U.S. Pat. No. 5,497,451 filed Jan. 22, 1992 and issued Mar. 5, 1996.

Computerized Method Using Isosceles Triangles for Generating Surface Points. U.S. Pat. No. 5,649,079 filed Feb. 28, 1994 and issued Jul. 15, 1997.

Method and Apparatus for Determining Offsets of a Part from a Digital Image. U.S. Pat. No. 7,522,163 filed Aug. 26, 2005 and issued Apr. 21, 2009.

These patents are incorporated herein by reference.

Much of the noted work by the present inventor is focused on modeling utilizing still camera images. The present invention does not primarily rely on still images of the material object that is to be modeled. The present invention provides a new method and apparatus for collection of data regarding contours and dimensions of a physical object and which may then be used for further processing.

### SUMMARY OF THE INVENTION

It is an object of the present invention to provide apparatus and a method to rapidly and easily collect information about a physical object to permit further processing for geometric modeling.

It is another object of the present invention to provide apparatus and a method which will facilitate precise guidance of a tool.

It has now been found that these and other objects of the present invention may be achieved in a method for collecting data for geometric modeling of a physical object which includes providing a first housing; providing an aperture in the first housing; providing a source of light within the housing that is strong enough to be perceptible in the ambient conditions at the aperture; providing a video recorder in a second housing; providing a rigid follower dimensioned and configured for following the surface of the physical object; rigidly fixing the rigid follower to one of the housings; and translating the follower along the surface of the physical object and simultaneously using the video recorder to video record the path of the aperture.

In some embodiments of the method the step of rigidly fixing the rigid follower to one of the housings fixes the rigid follower to the first housing. The step of providing a rigid follower may include providing a surface thereon for contacting the physical object that has a radius of curvature. The step of providing a rigid follower may include providing a surface thereon for contacting the physical object that has a radius of curvature and the radius of curvature thereof may be less than the radius of curvature of any part of the physical object over which the follower is translated.

The method may have a step of providing a rigid follower that includes providing a surface thereon for contacting the physical object that has a radius of curvature and the radius of curvature thereof is less than the radius of curvature of the physical object and also providing a follower that has cylindrical section contact surface. Other embodiments of the method further includes detecting the centroid of light visible within an aperture that is carried in coaxial relationship with a follower that has a cylindrical section shape and is carried on an elongated member.

In some forms of the invention the method further includes measuring the ratio of the change in the apparent size of the aperture at the aperture centroid projected onto a datum of the aperture path divided by the tangent of the aperture path. The method may include offsetting the elongated member from the axis of the aperture to proportionally increase the detection of the physical object dimensional deviation traced on the surface of the physical object by the path of the aperture centroid to a magnitude less than the radius of the rod.

Some embodiments of the method may further include the step of detecting the centroid of the aperture in the video recording at successive intervals during the translation of the follower over the physical object. The method may also include the step of measuring the ratio of the successive aperture sizes at the center point position of the aperture divided by the tangent to the successive aperture center points. In some cases the method also includes utilizing the tangent to a space curve traveled by the aperture as a representation of the point on a sphere that is used to generally represent the aperture centroid having a tangent plane parallel to the image plane.

Other embodiments of the method may further include utilizing the measurable diametric change as the average ratio in contour segment slope divided by the slope of a rectangular area; providing an aperture in the housing includes providing an aperture that is generally planar; the step of providing an aperture in the housing includes providing an aperture that is generally planar and the step of providing a rigid follower includes providing a follower having a surface for contacting a work piece that is in oblique relation to the axis of a plane defined by the aperture; and/or measuring the change in the apparent aperture size projected on an image plane relative to a segment of the space curve on the aperture path to produce a parameter that is a function of the change in depth perspective.

Embodiments of the present invention also include the apparatus for collecting data for geometric modeling of a physical object in cooperation with an associated video recorder in a housing and which includes a first housing having an aperture in the housing; a source of light within the housing that is strong enough to be perceptible in the ambient conditions at the aperture; and a rigid follower dimensioned and configured for following the surface of the physical object that is rigidly fixed to the housing.

Some embodiments of the apparatus include a rigid follower that has a surface thereon for contacting the physical object that has a radius of curvature on the surface for contacting the physical object that has a radius of curvature and the radius of curvature thereof is less than the radius of curvature of any part the physical object over which the follower is translated. Furthermore the apparatus may have a rigid follower that may be cylindrical and the aperture may be generally planar. The apparatus may have an aperture that is generally planar and the follower may have a surface for contacting a work piece that is in oblique relation to the axis of a plane defined by the aperture.

Other embodiments of the present invention also include the method for guiding a tool which includes providing a first housing; providing an aperture in the first housing; providing a source of light within the first housing that is strong enough to be perceptible in the ambient conditions at the aperture; fixing the first housing to an associated tool; providing a video recorder in a second housing; video recording the light visible through the aperture as the tool is moved with respect to an object.

Still other embodiments of the present invention include a method for replicating a part which includes providing a first housing; providing an aperture in the first housing; providing a source of light within the housing that is strong enough to be perceptible in the ambient conditions at the aperture; providing a video recorder in a second housing; providing a rigid follower dimensioned and configured for following the surface of the physical object; and rigidly fixing the rigid follower to one of the housings; in addition to translating the follower along the surface of the physical object and simultaneously using the video recorder to video record the path of the light visible at the aperture as well as providing a third housing; providing an aperture in the third housing; providing a source of light within the third housing that is strong enough to be perceptible in the ambient conditions at the aperture; fixing the third housing to an associated tool; providing a video recorder; video recording the light visible through the aperture in the third housing as the tool is moved with respect to an object.

The method for guiding a tool with respect to a work piece may include providing a first housing; providing an aperture in the first housing; providing a source of light within the housing that is sufficiently strong to be perceptible in the ambient conditions at the aperture; providing a video recorder in a second housing; fixing one of the housings to the tool; fixing the other of the housings in fixed relation to the work piece; moving the tool with respect to the work piece; video recording the aperture; and utilizing the video recording to guide the tool with respect to work piece. The method may further include the step of rigidly fixing a rigid follower to one of the housings.

### BRIEF DESCRIPTION OF THE DRAWING

The invention will be better understood by reference to the accompanying drawing in which:

FIG. 1 is an isometric view of a first embodiment of apparatus in accordance with one form of the present invention including an elongated housing which in this embodiment constitutes an elongated cylindrical follower intended to be translated about a physical object.

FIG. 2A is a front partially schematic view of a second embodiment of apparatus in accordance with one form of the present invention that includes a coaxial rod that is substantially coaxial with light emanating from an aperture (not shown) defined by a sleeve.

FIG. 2B is a front view of a third embodiment of apparatus in accordance with one form of the present invention that includes a V-shaped follower.

FIG. 3A is a front partially schematic view of a fourth embodiment of apparatus configured for attachment to an associated tool 23.

FIG. 3B is a side partially schematic view of the fourth embodiment of the apparatus shown in FIG. 3A.

FIG. 4 is a side view of a fifth embodiment of the present invention that includes a cylindrical section shaped follower intended to be translated along a physical object.

FIG. 5 is a side view of a sixth embodiment of the present invention that is similar to the first embodiment illustrated in FIG. 1 except for the addition of a plate.

FIG. 6 is a front view of the embodiment illustrated in FIG. 5.

FIG. 7 is an isometric view of the embodiment shown in FIG. 1 being translated along a work piece.

FIG. 8 is an isometric view of the apparatus illustrated in FIG. 4 having a cylindrical section shaped follower that is fixed to a video camera.

FIG. 9 is an isometric view of a still another embodiment of the present invention that includes a rectangular housing.

FIG. 10 is an isometric view of a still another embodiment of the present invention that combines the apparatus and method to model a physical object with the method and apparatus to guide a tool to replicate the physical object.

### DESCRIPTION OF THE PREFERRED EMBODIMENTS

The dimensions of a material object may be measured with a light can result in accurate measurement of the material part. With readily available electronic video capture devices transforming the dimensions of an apparent light source to a numerical quantity is very practical. Particularly useful is the ability to make relative comparisons between two parts that are fit together inclusive of a plurality of parts that would have a common base dimension. Providing the means to make measurements with hand held devices greatly simplifies the measurement of a part in the context of being able to manually produce dimensional data that contains a useful element of perspective. The perspective generated by using the apparatus and method of the invention is the basis for developing the measurements in scale to the size of parts within high tolerances. The apparatus of the present invention utilizes depth detections of the light visible through an aperture as the aperture is moved in a substantially fixed relationship to a surface of a physical object. Measuring a material part and using the dimensional data produced computationally in representing material objects on a digital computer provides scaled properties equivalent to the geometric dimensions of a multitude of features.

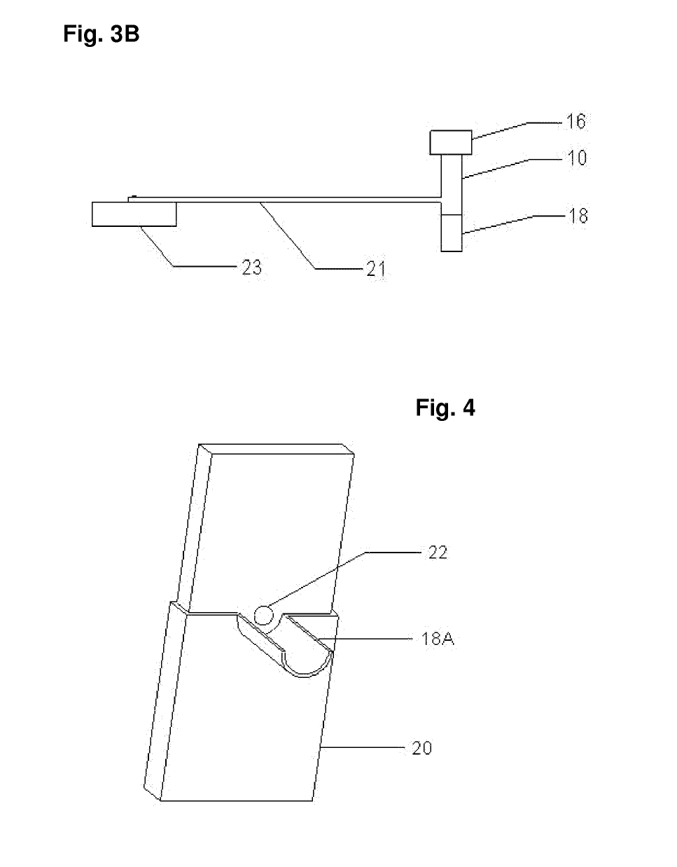

The method and apparatus in accordance with the present invention relates to producing the transform of space that maintains a useful part of the description of material space using readily available video cameras. The flexibility of the apparatus and method of the present invention permits the definition of the relative offsets in a simple completely portable system. A medium of communicating with a common digital processor in general context that is definitive and adaptable produces broad interpretations of spatial modeling compatible with transformations done in available programming computer interfaces. See, for example, Knoplioch et al. U.S. Pat. No. 7,191,101 entitled Method Of Semiautomatic Segmentation For The Estimation of Three-Dimensional Volumes, issued Mar. 13, 2007 FIG. 3 and Migdal et al U.S. Pat. No. 6,262,739 entitled System And Method For Computer Modeling Of 3d Objects or Surfaces by Mesh Constructions Having Optimal Quality Characteristics and Dynamic Resolution Capabilities, describe practical and useful analogies.

The recording with a camcorder of the aperture surrounding a light source relies on a determination that the circle having a center point is a convenient computer description of a spherical section. A spherical section having a center point is the location that a plane parallel to the image plane touches on a sphere. A sphere is used to represent the affine space of the average aperture centroid. In this application, the sphere supplements the affine transformation of the linear transformations used to describe the displacement of the aperture centroid at different positions of the aperture path. The tangent to the space curve traveled by the aperture is a representation of the point on the sphere that is used to generally represent the aperture centroid having a tangent plane parallel to the image plane. Relatively small movements of the camera over the distance to the aperture apparent local coordinate systems are translated by small magnitudes into the image.

With the present system, at any point in a traced path, the description is simultaneously held between a 3 dimensional point and a center of a definition for a spherical computer model simulation that is a representation of an object centroid. The Wikipedia article for the term “tangent” states “In geometry, the tangent line (or simply the tangent) to a curve at a given point is the straight line that “just touches” the curve at that point (in the sense explained more precisely below). As it passes through the point where the tangent line and the curve meet, or the point of tangency, the tangent line is “going in the same direction” as the curve, and in this sense it is the best straight-line approximation to the curve at that point. The same definition applies to space curves and curves in n-dimensional Euclidean space.” This passage contains an illustration showing a tangent plane to a point on a sphere. The plane is the parallel plane to the image plane. Reference to the “object centroid” is the point of the tangent to a sphere in this case being the aperture centroid.

The apparatus in accordance with the present invention is completely free to be translated in space. “Completely free to be translated” refers to the qualities of using a sphere as an object centroid for a model. This allows the tangent plane to translate in space to any point on the sphere so as not to be restricted in the process of representing the image plane from a preferable perspective of the material part. It is a standard CAD system programming technique for developing spatial references.

Variations in the radius of the sphere are representative of different parts. A sphere of infinite radius represents the aperture path of a planar physical object. Reducing the radius represents a part having dimensions that define depth. The center of the sphere is perpendicular to the image plane located at the average center of the aperture. In an affine space “there is no distinguished point that serves as an origin” thus, the center of the sphere can project into the image plane or out of the image plane.

Incremental affine transformations of the local coordinate system are projected directly into the image plane that freely follows the space curves as a series of affine spaces. Wikipedia in an article entitled “affine space” space includes “In mathematics, an affine space is a geometric structure that generalizes the affine properties of Euclidean space.” (Holmes patent U.S. Pat. No. 7,522,163B2 line 21-22, col 7 describes coordinate systems that are free to rotate where any number of axis are reset to the specific offset.)

Since the degrees of freedom are largely unconstrained, variations in methods used to manually record the device aperture path are used to include an element of time through smooth simultaneous movement (Rieder et al U.S. Pat. No. 4,695,720 issued Sep. 22, 1987 entitled Optoelectronic Incremental Measuring System With Adjustable LED positioning states in the abstract “The signals generated by receivers can be adjusted relative to each other in amplitude and phase because the positions of the light-emitting diodes are individually adjustable.”, “The phase relation between signals generated in a receiver associated with a given light-emitting diode and the signals generated in the other receivers can be corrected by a slight change in the direction in which light is emitted by a light-emitting diode. Differences of relative spatial offsets measured as the geometric tangents of a path, are equivalent to determining where a feature of a material part will translate to as the object moves from a recordable position.

The light visible through the aperture 12 produced by the light source 14 must have an intensity that is higher than ambient light. This light energy is used in the present invention to imprint a datum with data of the x, y image plane coordinates of the sequential positions of the light visible through the aperture. Calculating that next position in relation to path direction and variation of aperture size provides a means to make rapid qualifications based on low tolerances for possible directions of the path.

The next position of the tool is defined by an angular translation calculated from the movement of an aperture that is the linear change of the line from the aperture center to the shortest distance on the tangent line (see Wikipedia article cited supra) on the space curve of the aperture path. (Wikipedia in an article entitled “curve” includes the statement “A space curve is a curve for which X is of three dimensions, usually Euclidean space; a skew curve is a space curve which lies in no plane. These definitions also apply to algebraic curves. However, in the case of algebraic curves it is very common not to restrict the curve to having points only defined over the real numbers.”) Changes of adjacent positions in the aperture centroid detected at the sensor are divided by the distance of the aperture center to the tool position resulting in an angular offset. A linear measure of the tool angular offset is based on small displacements where the changes in orientation of the image plane are arbitrary.

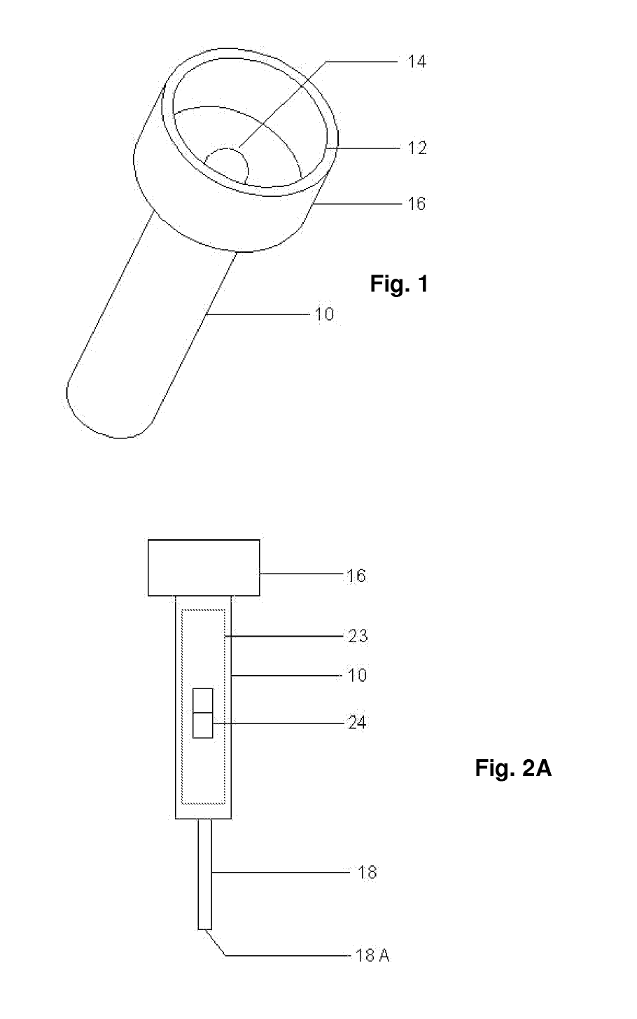

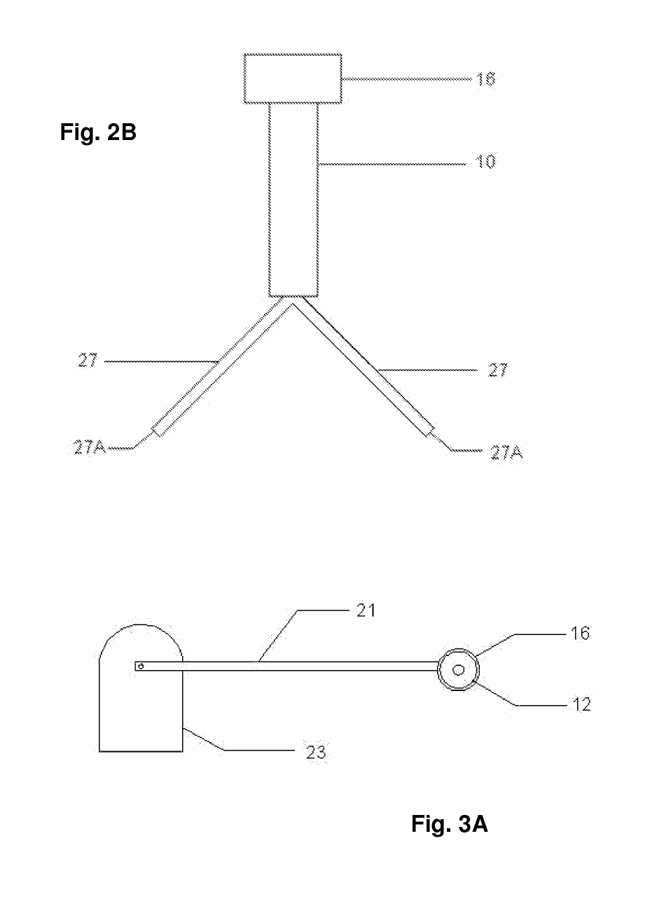

Referring now to FIG. 1, one form of the apparatus in accordance with the present invention includes a housing 10 having a circular aperture 12 therein through which visible light emanating from a light source 14 is visible. Other embodiments of the apparatus may have a polygon shape aperture that approaches a circular shape. Still other embodiments may even have a rectangular shape. The light visible at the aperture 12 defined by the sleeve 16 preferably has an intensity and sufficient diameter for recording the path of the aperture 12 with a digital video capture device. In the FIG. 2A embodiment of the present invention a follower 18A carried on a rod 18 that extends from a housing 10. The follower 18 in some embodiments is merely a rigid surface that is rigidly connected to the surface in which the aperture is formed. It is the axial extremity of this rod 18, referred to as follower 18A, that is translated along the surface of a material object to be analyzed. In the embodiment of FIG. 2B rods 27, 27 extend in oblique relation to the center of the aperture defined by the sleeve 16. The respective free ends of the rods 27, 27 are followers 27A, 27A.

The harvesting of the data required for final processing that calculates the edge feature traced by the light path might intuitively suggest that the axis of the video recorder lens has to be (or is preferably) parallel to the axis of the aperture. In practice, the reality is that such precise orientation is not necessary. This is consistent with the reality that useful data may be collected with a video camera that is handheld and manually operated contrary to what might intuitively require an elaborate mounting of the camera on a track and movement laterally on the track to maintain the axis of the video recorder lens parallel to the axis of the aperture.

In one form of the invention the rod 18 is rectilinear and also coaxial with a line on which the sleeve 16 is carried. In many embodiments, the movement of the sleeve 16 is preferably within planes that are parallel to the image plane of the material object being analyzed. The term “apparent plane” definitively references a view of the 3d world through the plane of the camera display. Wikipedia defines “image plane” as that plane in the world which is identified with the plane of the monitor.” In the method and apparatus of the present invention the consecutive points of an aperture path representative of a physical object are at a minimum one pixel distance apart, with a data collection rate of the video camera held by a human hand of sufficient speed for forming a compatible tangent between two points in the direction of a space curve representing the surface of a manifold. Because the data collection of the present invention is based on locating a plurality of singular points representing the average centroid of the aperture 12, the video recorder is free to translate outside the bounds of a two dimensional plane.

Thus, a video camera oriented toward the aperture 12 and generally approaches a line that is coaxial with the follower 18 and substantially perpendicular to a plane defined by the aperture 12 may record geometric data regarding the material object over which the follower 18 is translated. Stated another way, the rod 18 in the illustrated embodiment is a cylindrical rod 18 that has an axis that extends substantially perpendicular to the plane of the aperture and the rod axis intersects the center point of the circular aperture 12. More specifically, the axial extremity of the rod 18 is the follower 18A. The follower 18A in some embodiments has a radius that is less than the radius of the material part.

The dimensions and shape of the aperture 12 as well as the intensity of the light passing through the aperture 12 are selected so that the light emanating from the aperture 12 is perceptible by a video camera at ambient lighting conditions when the apparatus is moved so that the follower translates over the surface of a material object.

FIG. 1 is an isometric view of a first embodiment of apparatus in accordance with one form of the present invention including an elongated housing 10 which in this embodiment constitutes an elongated cylindrical follower intended to be translated about a physical object. An aperture 12 defined by a sleeve 16 surrounds a light source 14 from which light is visible at the aperture 12 and that visible light is substantially coaxial with the housing 10.

FIG. 2A is a front partially schematic view of a second embodiment of apparatus in accordance with one form of the present invention that includes a coaxial rod 18 that is substantially coaxial with light emanating from an aperture (not shown) defined by the sleeve 16. The rod 18 may have a radius that is equal to the radius of the housing 10. Ordinarily, the rod will have a radius that is less than the radius of the housing 10. Other embodiments may have a housing 10 that is not cylindrical. The housing 10 in this embodiment holds batteries 23. Mounted on the housing 10 is an external switch 24.

FIG. 2B is a front view of a third embodiment of apparatus in accordance with one form of the present invention that includes first and second legs 27, 27 legs that are both disposed in oblique relationship to the axis of the aperture. The legs have respective axial extremities or followers 27A and 27A. This embodiment also includes a sleeve 16 defining an aperture from which a light is visible. The axial extremities or followers 27A and 27A are simultaneously translated over a surface. For example, the surface may be a curvilinear plane such as a boat or car body. The path of the aperture has a curvature proportional to the relative change in depth between the pair of end points touching the material part. When two surfaces are compared through measuring the differences of the aperture path, a significant level of accuracy is available for determining where the surfaces differ.

FIGS. 3A and 3B are respectfully a front partially schematic view and a side partially schematic view of a fourth embodiment of apparatus in accordance with the present invention including an arm 21 attached to a housing 10 attached to a follower 18 that includes a sleeve 16. This assembly is configured for attachment to an associated tool 23. Although the follower 18 is shown as being the same diameter as the housing 10, other embodiments may have a follower that has a larger or smaller diameter than the housing 10. It will be understood that the follower 18 follows the work piece as the tool such as a circular saw or saber saw is cutting the same work piece. The attachment to a tool has the utility of facilitating precise guidance of the tool.

FIG. 4 is a side view of a fifth embodiment of the present invention that includes a cylindrical section shaped follower 18A intended to be translated along a physical object. The cylindrical section 18 is substantially coaxial with the video camera lens 22 of a video camera 20 within a housing. As in the other embodiments, a video camera has a lens with an optic axis that is preferably disposed in substantially coaxial relationship with the light as the follower 18A is translated about a physical object.

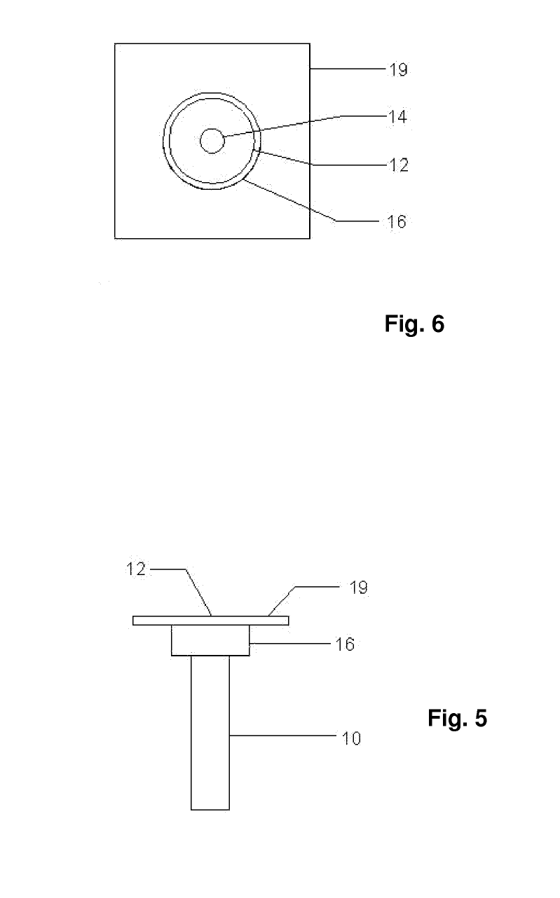

FIG. 5 is a side view of a sixth embodiment of the present invention. This embodiment is similar to the first embodiment illustrated in FIG. 1. A distinction is the inclusion of a plate 19 attached to the sleeve 16. The plate 19 is disposed in substantially parallel relationship to a plane in which the aperture 12 is defined. It will be understood that the aperture 12 may be defined in a housing as shown in FIG. 4. However, in an embodiment such as that shown in FIG. 1 an aperture 12 is defined by a sleeve 16. In such embodiments, the plane of the aperture will be understood to mean a plane that is substantially perpendicular to the axis of the sleeve 16 and touches the axial extremity of the sleeve 16 most remote from the light source 14 from which light is visible.

The plate 19 provides a high contrast with respect to the light visible from the aperture. More specifically, a plate of uniform material reflects a color of ambient light that highlights the expected contrast of the aperture light from the light color reflected from the plate. This plate 19 is removable for use in dark conditions. In brighter light or low contrast conditions the plate 19 provides a known color reference in general lighting conditions. Some embodiments may have concentric circular sections having unique colors to further maximize contrast with respect to the light that is visible from the aperture.

FIG. 6 is a front view of the embodiment illustrated in FIG. 5 having a plate 19 attached to the sleeve 16 in the plane of the aperture 12.

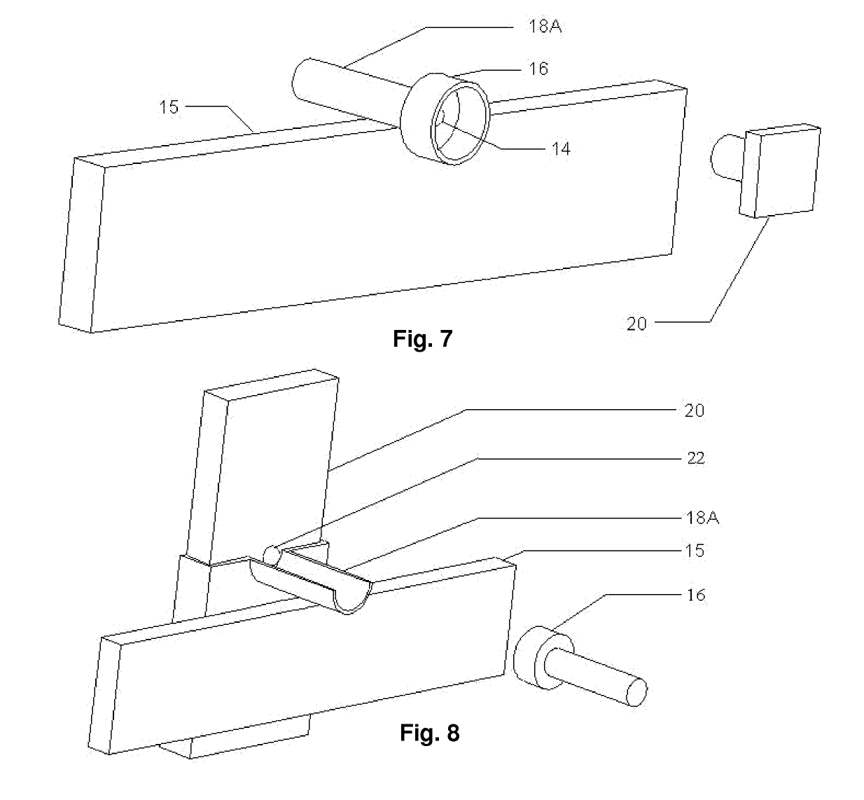

FIG. 7 is an isometric view of the embodiment shown in FIG. 1 being translated along a work piece 15 with the light from a light source 14 visible through the aperture 12 disposed in coaxial relationship with an aperture defined by a sleeve 16. A video camera 22 captures the material information relating to the contours of the work piece 15.

FIG. 8 is an isometric view of the apparatus illustrated in FIG. 4 having a cylindrical section shaped follower 18A that is fixed to a video camera 20 having a lens 22. The optical axis of the camera lens 22 and the axis of the cylindrical section shaped follower 18A are coaxial. As the cylindrical section shaped follower 18A is translated along the work piece 15 the video camera captures information about the physical characteristics of the work piece because the alignment of the camera with respect to light visible through an aperture defined by a sleeve 16 changes as the translation occurs. Thus, the image captured by the camera contains the desired information.

The light emanating from the aperture defined by the sleeve 16 is typically at a distance where the translation of the cylindrical section shaped follower 18A is substantially perpendicular to the line between the camera with the light source and the light source. The light can also be raised above the cylindrical section shaped follower 18A to eliminate interference with the camera.

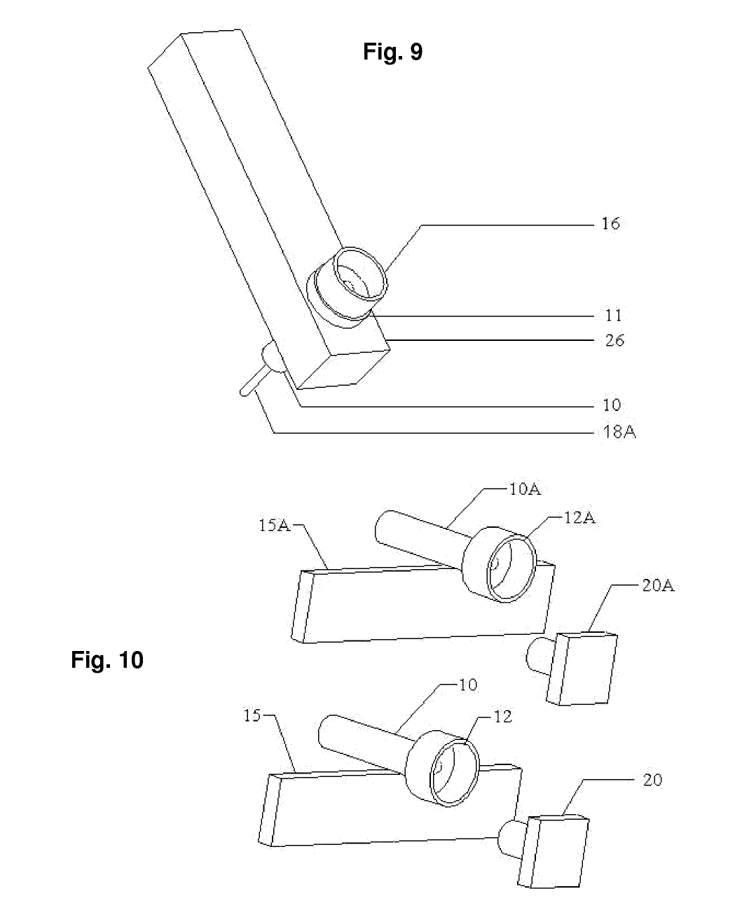

FIG. 9 is an isometric view of a still another embodiment of the present invention that includes a rectangular housing or handle 26 attached to a cylindrical sleeve 16. As in other embodiments a light is concentric with a cylindrical sleeve 16 that produces light that is visible at the aperture defined by the cylindrical sleeve 16. Disposed in substantially coaxial relationship to the light and the cylindrical sleeve 16 is a cylindrical follower 18A fixed to the rectangular housing 26. In some cases the rectangular housing 26 may be used as a handle to translate the cylindrical follower 18A about a physical object.

As used herein, the term “visible” refers to being visible to a video recorder not merely visible to a human being. Thus, for example, infra-red light may be utilized.

The apparatus in accordance with one form of the present invention is a tool that includes an appendage that when translated about the contours of a 2 or 3 dimensional physical object to derive general dimensional effects as an analog measurement of space. This analog measurement is easily integrated with digital devices. In one form of the apparatus a circular aperture emitting light from a hand held container has an attached rod 18 that is translated over the surface of a material object. The path of a series of successive aperture positions recorded by a video recorder provides the dimensional parameters characteristic of the shape of a particular material object. More particularly, the video recorder recording includes data reflecting small variations in a traced path along the surface of a material object. This data may be used to make useful generalizations about the dimensions of the physical object in the perspective specific to the orientation of the physical object.

The tool may be (1) hand held device or (2) a cutting or forming tool. The tool and the method in accordance with the present invention rapidly generates the generalized dimensions of a material object. Visible light that is brighter than the ambient light is a highly effective in recording the path of the follower 18 through space.

The path of the light allows generalizations of the dimensions coupled to the degrees of potential variation with respect to motion are easily measured. The apparatus in accordance with the present invention and the video recording apparatus recording the path are translated freely in all degrees of freedom. No rigid datum or material platforms are required. This is a significant advantage because the method and apparatus are thus completely portable. Significant systems exist that provide highly accurate measurements ranging from stylus contact with a part to laser guided multiple camera machines. This device is used to measure the relative change in path over the axial extent of the path. The measurement of the tangential change of a part surface determines the offset of the aperture path from a master part.

The change in the tangent space (Wikipedia in an article entitled “tangent space” defines “tangent space” as “In mathematics, the tangent space of a manifold facilitates the generalization of vectors from affine spaces to general manifolds, since in the latter case one cannot simply subtract two points to obtain a vector pointing from one to the other.”) along the path of the aperture is the projection of the material part represented as a manifold in an affine transformation at the aperture centroid. (Wikipedia in an article entitled “Manifold” states “a manifold is a topological space that on a small enough scale resembles the Euclidean space of a specific dimension.”)

Holmes patent U.S. Pat. No. 7,522,163 describes a means to accurately determine the difference of two compared parts using single images that are digitally prepared by a person. Results are practically limited to two dimensional planes. The position of the sleeve 16 relative to the alignment with the material part is the datum described by the offset of the aperture 12 from a material edge that is displayed on the image plane of a video capture device. Thus, the method and apparatus of the present invention is a practical tool for measuring objects in all dimensions in a variety of environments benefiting from the advantage of using today's recording devices, including but not limited to wireless cameras.

The generality of the spatial parameters derivable from the light paths made with the device is readily transformed into data that is adaptable as the projection of an object on a 2 dimensional digital image. Inter-pixel modeling of parts as described in the present inventor's U.S. Pat. No. 7,522,163 is a means to calculate the sum of tangential alignments in preparing images for more rigorous reverse operation of object identification. This is useful in determining the position and orientation of an object displayed on a 2d image contained in outwardly projected blocks 4000 as described in the present inventor's U.S. Pat. No. 7,522,163 issued Apr. 21, 2009 from each path point with hexahedron block sides aligned to a common datum. Contemporary CAD systems use the aligned datum blocks where the difference is the device provides a means to measure the dimensions between the blocks eliminating the need to define the location position of the material part.

In some embodiments of the apparatus in accordance with the present invention the construction of the aperture assembly includes a light visible through a generally circular planar aperture. An associated video camera is utilized to record the light visible from an aperture. Although the structure defining the aperture may be carried on an elongated member, other embodiments may provide a very thin structure that has an aperture defined therein. Theoretically, the thickness may be infinitesimally small. Some rigid follower must be also provided that is preferably aligned with a perpendicular to the aperture substantially pointing at a camera recording device. A hand held video camera is highly effective in recording spatial dimensions of the lighted aperture path. Further operation of the device used in moving the rod along the exterior surface of a material part provides highly accurate video of the light aperture path proportional to the apparent edges of an object because the center of the aperture does not vary regardless of the difference in apparent aperture diameter.

The center of the aperture has a shortest distance from the tangent line of the space curve representing the path of the aperture that changes in length linearly with the change in depth of the aperture path. For practical purposes the magnitude of the shortest distances are constant. With an affine transformation on the line segment from the aperture extended normal to the tangent line contacting the space curve, a convenient orientation is available for measuring the space curve in an image plane. The differences of the change of tangent line slope to the space curve of equivalent parts is zero.

In some embodiments of the apparatus in accordance with the present invention the construction of the aperture assembly that is perpendicular with the cylindrical rod axis is mounted on a simple container typically shaped as a rectangle. Contemporary cosmetic containers in the form of soap dishes and tooth brush holders work well for attaching the light aperture, rod, light source, and power supply.

A useful feature of the data collection method and apparatus of the present invention is the elimination of barriers to the scale of measuring a material part and is not limited to a specific planar or linear datum describing a specific feature of the part. Holmes patent U.S. Pat. No. 7,522,163 describes existing systems and methods for measuring relative part offsets. (See, for example, Holmes U.S. Pat. No. 7,522,163, element 4000)

As the variation in aperture size is recorded from a camera focal point, the relation of adjacent fluctuations in path depth equals the cubic (col 25, line 47, Holmes U.S. Pat. No. 7,522,163) form (FIG. 4. Holmes U.S. Pat. No. 7,522,163) where volumes of space 4001, 4002 are expanded outward at angles containing the quadratic curves (col 3, line 20, Holmes U.S. Pat. No. 7,522,163; col 4, line 66; col 13, line 23) contained in an overlay 500.)

The method and apparatus of the present invention defines a path that is the contours and dimensions of the physical object by measuring the change in the tangent of the aperture path space curve. Physical objects are measured by the difference of the relative part offsets of the aperture path space curves projected on the image plane. Adjacent aperture path points have tangents of homogeneous coordinates on the space curve of a slope in the tangent plane perpendicular to the image plane. Slope defines the relative outward angles containing quadratic curves along the homogeneous coordinates of adjacent points on the path space curve. Relative depth along adjacent points on a path is detected as the diameter of the circular aperture changes as the distance from the focal point of a recording camera varies. The relative depth of sequential points on the aperture path is detected from the diametric change in the aperture from the distance to the focal point of the video recording device.

The diametric change is measurable as the statistical offset of the homogeneous coordinates defining a tangent at a point on the aperture path. A rectangular area centered at the aperture path point is defined having a center at the path point with coordinates in the image plane of the minimum and maximum coordinate positions of the interior contour segments. (Holmes U.S. Pat. No. 7,522,163 col 5, lines 53-57 references edge features, in this case contour segments, to the linear location between pixels on a display). The ratio of (1) the average difference of the contour segments slopes derived from the homogeneous coordinates of the tangents in the image plane to (2) the slope of two adjacent sides of the rectangular area is compared to an arbitrary constant. Differences in relative depth are detectable by minor increases in the ratio greater than an arbitrary constant magnitude irrespective of the orientation or size of the block area.

The size of the device is fully scalable, thus, followers that are cylindrical sections may be dimensioned to follow essentially every contour of virtually any physical object. Ordinarily the follower will have a cylindrical section contact surface having a radius that is less than the radius of any radius of the physical object.

The method and apparatus of the present invention may be used to guide a tool. In a typical application a housing such as that shown in FIGS. 3A and 3B that includes a cylindrical sleeve 16 from which light is visible is attached by an elongated member 21 to a tool 23. Recording the path of the aperture defined by the sleeve 16 enables the user of the tool to conform the path of the tool 23 during a cutting or other machining operation and thus achieve much greater precision than would otherwise be possible. Apertures from which light is visible are easily mounted, for example on any cutting tool as shown in FIG. 3A. A tool path is calculated from a physical object by measuring the change in the tangent to the space curve of the aperture path. The variation in the slope of the tangent on consecutive aperture path points indicates a material feature on the surface of a physical object requiring modification in the tool path. Extensions 21 of the housing 10 may be attached to various tools such as hand held power tools including but not limited to drills, saws, and power planes. Such combinations are useful in guiding the power tool.

FIG. 10 is an isometric view of a still another embodiment of the present invention that combines the apparatus and method to model a physical object 15 with the method and apparatus of the present invention to guide a tool with the method and apparatus of the present invention to produce a replication 15A. The difference in the path tangent slope of the master follower 10 subtracted by the current path tangent slope of the replicating follower 10A is the additional change in direction of the replicating follower 10A to be translated to make a replicate part 15A. Also shown is a video camera 20A.

In such an embodiment a video recording 20 of the path defined by the light visible through a first aperture 12 provides data regarding a physical object. This data is compared with data produced by a video recording of the path of light visible through a second aperture 12A that is fixed to a tool. The quantity of pixels in typical industrial cameras will generate an image of sufficient resolution to guide a copy follower 10A that is set back by a degree of time from the master follower 10. Increasing the number of snap shots in the proximity of a high tolerance feature provides the relative measurements for determining the vector distance with orientation that corrects any deviations of the copy 15A from the master part 15 concurrent to duplicating the part.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for collecting data for geometric modeling of a physical object which comprises:
providing a first housing;
providing an aperture in the first housing;
providing a source of light within the housing that is strong enough to be perceptible in the ambient conditions at the aperture;
providing a video recorder in a second housing;
providing a rigid follower dimensioned and configured for following the surface of the physical object;
rigidly fixing the rigid follower to one of said housings; and
translating the follower along the surface of the physical object and simultaneously using the video recorder to video record the path of the aperture.

2. The method as described in claim 1 the step of rigidly fixing the rigid follower to one of said housings fixes the rigid follower to the first housing.

3. The method as described in claim 1 wherein the step of providing a rigid follower includes providing a surface thereon for contacting the physical object that has a radius of curvature.

4. The method as described in claim 1 wherein the step of providing a rigid follower includes providing a surface thereon for contacting the physical object that has a radius of curvature and the radius of curvature thereof is less than the radius of curvature of any part of the physical object over which the follower is translated.

5. The method as described in claim 2 wherein the step of providing a rigid follower includes providing a surface thereon for contacting the physical object that has a radius of curvature and the radius of curvature thereof is less than the radius of curvature of the physical object and providing a follower that has cylindrical section contact surface.

6. The method as described in claim 2 that further includes detecting the centroid of light visible within an aperture that carried in coaxial relationship with a follower that has a cylindrical section shape and is carried on an elongated member.

7. The method as described in claim 2 that further includes measuring the ratio of the change in the apparent size of the aperture at the aperture centroid projected onto a datum of the aperture path divided by the tangent of the aperture path.

8. The method as described in claim 1 that further includes offsetting the elongated member from the axis of the aperture to proportionally increase the detection of the physical object dimensional deviation traced on the surface of the physical object by the path of the aperture centroid to a magnitude less than the radius of the rod.

9. The method as described in claim 1 further including the step of detecting the centroid of the aperture in the video recording at successive intervals during the translation of the follower over the physical object.

10. The method as described in claim 1 further including the step of detecting the centroid of the aperture in the video recording periodically during the translation of the follower over the physical object and further including the step of measuring the ratio of the successive aperture sizes at the center point position of the aperture divided by the tangent to the successive aperture center points.

11. The method as described in claim 10 further including utilizing the tangent to a space curve traveled by the aperture as a representation of the point on a sphere that is used to generally represent the aperture centroid having a tangent plane parallel to the image plane.

12. The method as described in claim 10 further including utilizing the measurable diametric change as the average ratio in contour segment slope divided by the slope of a rectangular area.

13. The method as described in claim 10 wherein the step of providing an aperture in the housing includes providing an aperture that is generally planar.

14. The method as described in claim 2 wherein the step of providing an aperture in the housing includes providing an aperture that is generally planar and the step of providing a rigid follower includes providing a follower having a surface for contacting a work piece that is in oblique relation to the axis of a plane defined by the aperture.

15. The method as described in claim 2 further including measuring the change in the apparent aperture size projected on an image plane relative to a segment of the space curve on the aperture path to produce a parameter that is a function of the change in depth perspective.

16. Apparatus for collecting data for geometric modeling of a physical object in cooperation with an associated video recorder in a housing and which comprises:
a first housing having an aperture in the housing;
a source of light within said housing that is strong enough to be perceptible in the ambient conditions at the aperture; and
a rigid follower dimensioned and configured for following the surface of the physical object fixed to said housing.

17. The apparatus as described in claim 16 wherein said rigid follower has a surface thereon for contacting the physical object that has a radius of curvature.

18. The apparatus as described in claim 16 wherein said rigid follower has a surface thereon for contacting the physical object that has a radius of curvature and the radius of curvature thereof is less than the radius of curvature of any part of the physical object over which the follower is translated.

19. The apparatus as described in claim 16 wherein said rigid follower includes a surface thereon for contacting the physical object that has a radius of curvature and the radius of curvature thereof is less than the radius of curvature of any part of the physical object over which the follower is translated and said follower is cylindrical.

20. The apparatus as described in claim 16 wherein said aperture is generally planar.

21. The apparatus as described in claim 16 wherein said aperture is generally planar and said follower has a surface for contacting a work piece that is in oblique relation to the axis of a plane defined by the aperture.

22. A method for guiding a tool which comprises:
providing a first housing;
providing an aperture in the first housing;
providing a source of light within the first housing that is strong enough to be perceptible in the ambient conditions at the aperture;
fixing the first housing to an associated tool;
providing a video recorder in a second housing;
video recording the light visible through the aperture as the tool is moved with respect to an object.

23. A method for replicating a part which comprises:
providing a first housing;
providing an aperture in the first housing;
providing a source of light within the housing that is strong enough to be perceptible in the ambient conditions at the aperture;
providing a video recorder in a second housing;
providing a rigid follower dimensioned and configured for following the surface of the physical object; and
rigidly fixing the rigid follower to one of said housings; and
translating the follower along the surface of the physical object and simultaneously using the video recorder to video record the path of the light visible at the aperture as well as
providing a third housing;
providing an aperture in the third housing;
providing a source of light within the third housing that is strong enough to be perceptible in the ambient conditions at the aperture;
fixing the third housing to an associated tool;
providing a video recorder;
video recording the light visible through the aperture in the third housing as the tool is moved with respect to an object.

24. A method for guiding a tool with respect to a work piece which comprises:
providing a first housing;
providing an aperture in the first housing;
providing a source of light within the housing that is sufficiently strong to be perceptible in the ambient conditions at the aperture;
providing a video recorder in a second housing;
fixing one of said housings to the tool;
fixing the other of said housings in fixed relation to the work piece;
moving the tool with respect to the work piece;
video recording the aperture; and
utilizing the video recording to guide the tool with respect to work piece.

25. The method as described in claim 25 further including the step of rigidly fixing a rigid follower to one of said housings.
